(19) United States
(12) Patent Application Publication
(10) Pub. No.: US 2024/0091964 A1
(43) Pub. Date: Mar. 21, 2024

(54) Multidirectional Sensing Array for Robot Perception

(71) Applicant: Sarcos Corp., Salt Lake City, UT (US)

(72) Inventor: Fraser M. Smith, Salt Lake City, UT (US)

(21) Appl. No.: 17/946,684

(22) Filed: Sep. 16, 2022

(51) Int. Cl. B25J 19/02

(52) U.S. Cl. CPC B25J 19/021

(57) ABSTRACT

Disclosed herein is a robot sensing array for multidirectional sensing by a robot. The robot can include one or more robot body members. The sensing array can include a plurality of sensors radially supported on at least one of the one or more robot body members of the robot. The plurality of sensors can include a first sensor, a second sensor located on the at least one of the one or more robot body members at a first position adjacent to the first sensor, and a third sensor located on the at least one of the one or more robot body members at a second position adjacent to the first sensor. The first sensor of the plurality of sensors is disposed to have an overlapping field of view with the second sensor and the third sensor.

### BACKGROUND

Visualization and imaging in humanoid robots and other robotic systems is important for control of the robotic system as well as for providing visual information to a user, observer, or tele-operator of the robot. For example, humanoid robots may be controlled remotely by a human user who may control and navigate the robot based on visual information from the robot or may use the robot to obtain desired visualization of an environment. Additionally, cameras, image sensors and other visualization systems included on a robot may be used to allow the robot to autonomously move, navigate through an environment, and perform specified tasks based on computer instructions coded in a control system of the robot. For these reasons and others, development of robotic visualization systems is ongoing in the field of robotics. The same can be said for other perception and sensing functions other than visualization that a robot or robotic system may be configured to perform, such as sensing sounds, temperature, and others. These sensing functions can allow a robot or robotic device to perceive one or more aspects of an environment in which the robot or robotic device is operating.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates an isometric view of a humanoid robot according to an example of the present disclosure.

FIG. 2 illustrates a close-up isometric view of a head of the humanoid robot of FIG. 1.

FIG. 3A illustrates a front view of the head of the humanoid robot of FIG. 1.

FIG. 3B illustrates a left side view of the head of the humanoid robot of FIG. 1.

FIG. 3C illustrates a rear view of the head of the humanoid robot of FIG. 1.

FIG. 3D illustrates a right-side view of the head of the humanoid robot of FIG. 1.

FIG. 4 illustrates a top cross-sectional view of the head of the humanoid robot of FIG. 1

FIG. 5 illustrates an explanatory diagram of three-dimensional imagery and viewing where two cameras are imaging a scene.

FIG. 6A illustrates an exemplary image captured of the scene of FIG. 5 by one of the cameras.

FIG. 6B illustrates an exemplary image captured of the scene of FIG. 5 by one of the cameras.

FIG. 6C illustrates an exemplary viewable stereo image which is a combination of the images of FIGS. 6A and 6B.

FIG. 7 illustrates sensing regions of sensors supported on the head of a robot, including overlapping and non-overlapping regions, which are used to generate a field of view image.

FIGS. 8A and 8B illustrate an orientation of a user in an environment and a portion of a stereo image displayed to the user based on the user's orientation within the environment according to at least one example of the present disclosure.

FIGS. 9, 10, 11A and 11B illustrate various different configurations of where sensors may be disposed on a humanoid robot head according to examples of the present disclosure.

FIGS. 12A-12C illustrate alternate configurations of disposing sensors on a plane of a robot head in accordance with examples of the present disclosure.

FIG. 13 illustrates field of view overlap for sensors on a robot head in accordance with an example of the present disclosure.

FIG. 14A illustrates an orientation of a user in an environment and a user's field of view in the environment.

14B, and 14C illustrate exemplary stereo images displayed to the user on a display device based on the user's orientation within the environment.

FIG. 15 illustrates a front view of a humanoid robot according to an example of the present disclosure.

FIGS. 16 and 17 illustrate block diagrams of robotic systems according to examples of the present disclosure.

FIG. 18 is block diagram illustrating an example of a computing device that may be used to implement the technology disclosed herein.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

Disclosed herein is a robot sensing array for multidirectional sensing by a robot comprising one or more robot body members. The sensing array can include a plurality of sensors supported on at least one of the one or more robot body members of the robot. In one example, the sensing array can be radially supported as measured from a center or other identified point. The plurality of sensors can include a first sensor, a second sensor located on the at least one of the one or more robot body members at a first position adjacent to the first sensor, and a third sensor located on the at least one of the one or more robot body members at a second position adjacent to the first sensor. The first sensor of the plurality of sensors can be disposed to have an overlapping field of view or field of sensing with the second sensor and the third sensor.

Disclosed herein is a robot visualization imaging array for multidirectional imaging by a robot comprising one or more robot body members. The imaging array can include a plurality of cameras radially supported on at least one of one or more robot body members of the robot. The plurality of cameras can include a first camera, a second camera located on the at least one of the one or more robot body members at a first position adjacent to the first camera, and a third camera located on the at least one of the one or more robot body members at a second position adjacent to the first camera. The first camera of the plurality of cameras can be disposed to have an overlapping field of view with the second camera and the third camera.

Disclosed herein is a robotic system for multidirectional imaging or sensing by a robot. The system can include a robot comprising one or more robot body members. The system can further include an sensing array. The sensing array can include a plurality of sensors radially supported on at least one of one or more robot body members of the robot. The plurality of sensors can include a first sensor, a second sensor located on the at least one of the one or more robot body members at a first position adjacent to the first camera, and a third sensor located on the at least one of the one or more robot body members at a second position adjacent to the first sensor. The first sensor of the plurality of sensors can be disposed to have an overlapping field of view, or in other words a field of sensing, with the second sensor and the third sensor.

Disclosed herein is a computer implemented method of multidirectional imaging or sensing from a robot comprising one or more robot body members and an imaging array or another type of sensing array. The sensing array, which in one example can comprise an imaging array, can include a plurality of sensors supported on at least one of the one or more robot body members of the robot. In one example, the sensing array can be radially supported as measured from a center or other identified point. In one example, the sensors can be cameras. The method can comprise generating first data from a signal output by a first sensor. The method can further comprise generating second data from a signal output by a second sensor located on the at least one of the one or more robot body members at a first position adjacent to the first sensor. The method can further comprise generating third data from a signal output by a third sensor located on the at least one of the one or more robot body members at a second position adjacent to the first sensor. The method can further comprise combining the generated first data and second data to produce a first aggregate data output. The method can further comprise combining the generated first data and third data to produce a second aggregate data output.

The first sensor of the plurality of sensors can be disposed to have an overlapping field of view with the second sensor and the third sensor. In one example, the sensors can comprise cameras, and the data generated can comprise image data.

Disclosed herein is a method for facilitating multidirectional sensing by a robot comprising one or more robot body members. In one example, the multidirectional sensing can be multidirectional imaging or multidirectional stereo imaging. The method can include configuring the robot to comprise a first sensor. The method can further include configuring the robot to comprise a second sensor located on the robot at least one of the one or more robot body members at a first position adjacent to the first sensor. The method can further include configuring the robot to comprise a third sensor located on the at least one of the one or more robot body members at a second position adjacent to the first sensor. In one example, the sensors can be cameras. The first sensor can be disposed to have an overlapping field of sensing or overlapping field of view with the second sensor and the third sensor.

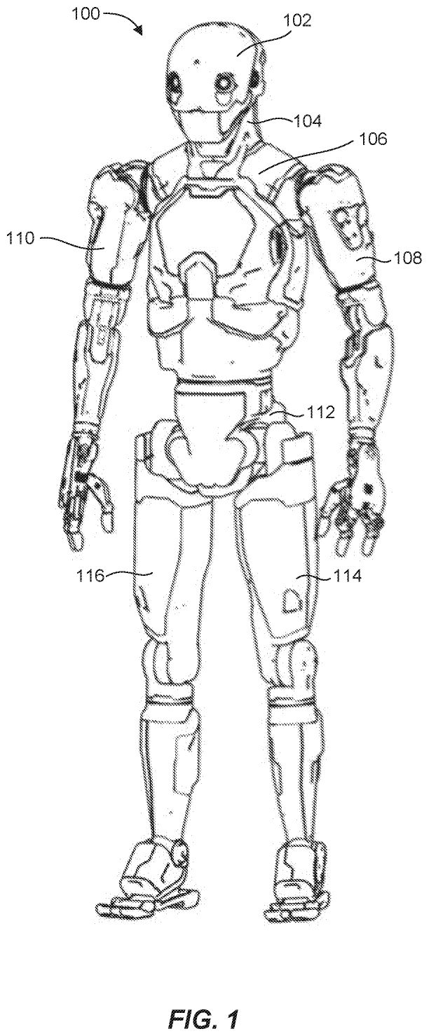

To further describe the present technology, examples are now provided with reference to the figures. Described herein is an imaging and/or sensing device supported on a robot. With reference to FIG. 1, illustrated is a humanoid robot 100, however, as indicated below, the present technology is not limited to application on a humanoid robot as the present technology can be incorporated into other robot types. Robot 100 comprises a plurality of body members, limbs, appendages, and surfaces configured to support various elements on the robot 100. For example, the robot 100 can include a head member 102, a neck member 104 that supports the head member 102, and a torso robot body member 106 that supports the neck member 104 and head member 102. Other members can also be supported on the torso robot body member 106 such as a left arm member 108 and a right arm member 110. The torso member 106 can be supported on a lower torso member 112, which can support a left leg member 114 and a right leg member 116.

It is to be appreciated that the devices, systems, and principles described herein can be applied to any robotic and/or imaging system. For example, the robot 100 can be a humanoid robot, a robotic exoskeleton, a tele-operated robot, a robotic arm, a stationary imaging support, a mobile imaging support, a legged robot, an unmanned ground vehicle, or any other apparatus, system, or device where imaging and/or sensing is implemented thereon.

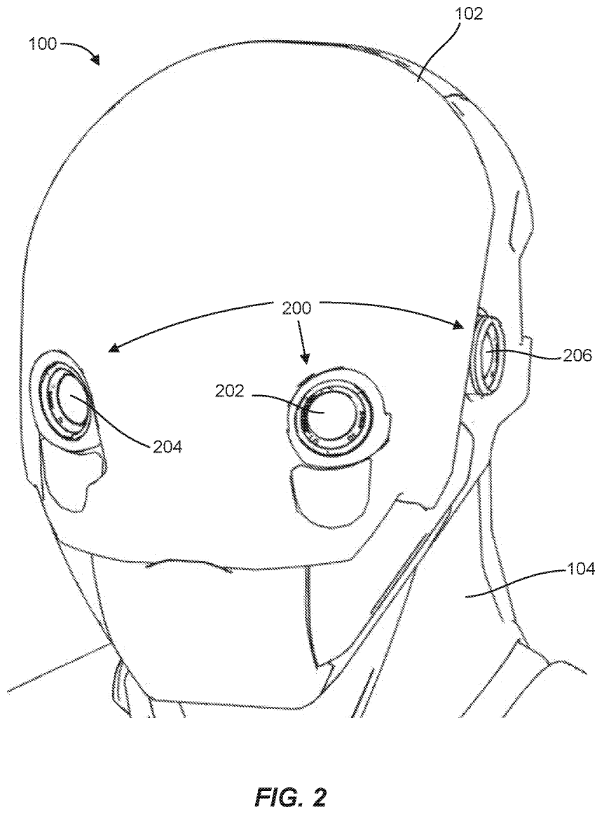

FIG. 2 illustrates a view of the head member 102 of the robot 100 having imaging sensing array 200 supported on the head member 102, which head member 102 is fixed relative to, and extending from, the torso robot body member 106 via the neck member 104. The neck member 104 can be rigidly or moveably connected to the head member 102 and/or torso robot body member 106. In other words, the head member 102 can be either moveable or stationary relative to the torso robot body member 106 by the connection of the neck member 104 to the torso robot body member 106.

As shown in FIG. 2, sensing array 200 can comprise a plurality of sensors that sense data from an environment around the robot 100 and in which the robot 100 is intended to operate. It is to be understood that the plurality of sensors can be any kind of sensor configured to provide information about any physical phenomena in an environment such as thermal data, audio data, image data, video data, distance data, mapping data, radiation data, magnetic data, any type of physical phenomena that can be sensed by a sensor, or any combination of thereof. As used herein, the term “physical phenomena” can include any observable, viewable, measurable, or sense-able scientific occurrence in an environment, including, but not limited to, electromagnetic radiation from both visible and invisible portions of the electromagnetic spectrum, electricity, magnetism, heat, radiation, sound waves, chemicals and chemical levels, or any others.

For the sake of simplicity, the examples discussed herein will be drawn to imaging functions as facilitated by cameras, and as such, the sensing array 200 can comprise an imaging array comprising a plurality of cameras. However, it is to be appreciated that any examples described herein are equally applicable to any sensing or recording of an environment and any physical phenomena surrounding a robot using any kind of sensors. Therefore, while the word “camera” is used when discussing the examples, the term “camera” is to be interpreted herein broadly as including any imaging, and/or recording device or system, any sensor that captures physical phenomena and outputs a signal representative of the phenomena captured to facilitate creation of image, audio, or other sensor data that can be used for display, analysis, or to provide information to a computer system. Additionally, any combinations of the above-described sensors can be used in conjunction with each other.

The sensing array 200 can include a first camera 202, a second camera 204 located on the head member 102 at a first position that is adjacent to the first camera 202 with respect to other cameras in the imaging array 200, and a third camera 206 located on the head member 102 at a second position adjacent to the first camera 202. As shown first, second, and third cameras 202, 204, and 206 are radially spaced around an outer perimeter of a common robot body member (e.g., head member 102) with the second camera 204 positioned to one side of the first camera 202 and the third camera 206 positioned to a side of the first camera 202 that is opposite the side on which the second camera 204 is disposed. As will be described in more detail later, the positions at which the first, second, and third cameras 202, 204, and 206 are placed on the head member 102 are placed such that the first camera 202 has a field of view that at least partially overlaps with the field of view of the second camera 204 and the field of view of the third camera 206.

While the sensors of the sensing array 200 are described as cameras herein, the disclosure is not intended to limit the scope of the sensors in anyway. The sensors can be imaging sensors (e.g., monochromatic image sensors, RGB image sensors, LIDAR sensors, RGBD image sensors, stereo image sensors, thermal sensors, radiation sensors, global shutter image sensors, rolling shutter image sensors, RADAR sensors, ultrasonic based sensors, interferometric image sensors, image sensors configured to image electromagnetic radiation outside of a visible range of the electromagnetic spectrum including one or more of ultraviolet and infrared electromagnetic radiation, and/or a structured light sensor), or any combination of these. Accordingly, while certain elements (e.g. elements 202, 204, 206, 302, 304, 306, 308, 310, 312, 500, 502, 904, 906, 908, 910, 912, 1004, 1006, 1008, 1010, 1012, 1104, 1106, 1108, 1110, 1112, 1114, 1116, 1118, 1120, 1122, 1124, 1126, 1128, C1-C8, 1202, 1204, and 1206) are identified as “cameras” herein, it is to be understood that any of these elements may be sensors of any kind and may be used to accomplish array sensing from a robot. For example, the cameras/sensors can provide fluorescence imaging, hyperspectral imaging, or multispectral imaging. Furthermore, the sensors can be audio sensors (e.g., microphones, sonar, audio positioning sensors or others), chemical sensors, electromagnetic radiation sensors (e.g. antennas with signal conditioning electronics), magnetometers (single axis and multi-axis magnetometer) and radars. In short, any sensor, imager, recorder, or other device, and any combination of these, can be used in the configuration of array 200 or any other array described herein. The cameras illustrated in the figures can be used to represent any known sensor.

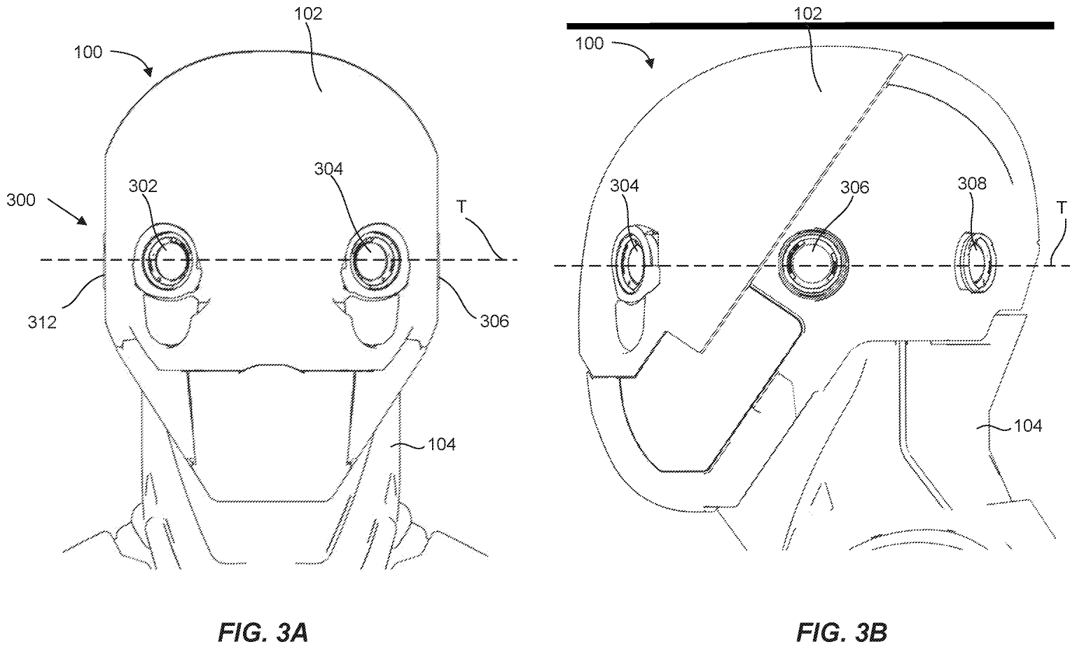

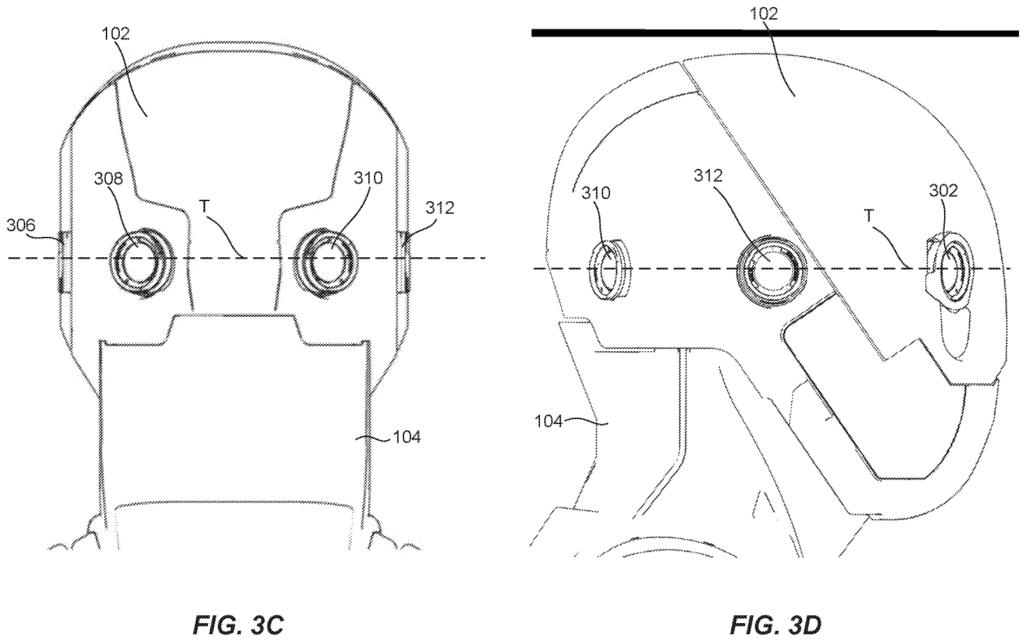

FIGS. 3A-3D illustrate a sensing array 300 comprising an imaging array, including additional cameras supported by and positioned around the perimeter of the head member 102. The sensing array 300 can comprise a plurality of cameras radially spaced around a perimeter of the head member 102 and supported on the head member 102. For example, a front view of head member 102 illustrates that sensing array 300 can include a first camera 302 and a second camera 304 positioned adjacent to first camera 302, each facing substantially forward (substantially forward including different radial positions where the first and second cameras 302, 304 are still able to image the environment and objects in the environment that are forward or in front of the robot 100) relative to the robot 100. FIG. 3B illustrates a left side view of the head member 102 and shows that a third camera 306 can be radially spaced from and positioned adjacent to the second camera 304 in the sensing array 300 and supported on the head member 102. A fourth camera 308 can be radially spaced from and positioned adjacent to the third camera 306 in the sensing array 300 and supported on the head member 102.

FIG. 3C illustrates a rear view of the head member 102 and further shows that the sensing array 300 can include a fifth camera 310 radially spaced from and positioned adjacent to the fourth camera 308 in the sensing array 300 and supported on the head member 102. The fourth and fifth cameras 308, 310 can each face substantially rearward (substantially rearward including different radial positions where the fourth and fifth cameras 308, 310 are still able to image the environment and objects in the environment that are rearward or behind the robot 100) relative to the robot 100. FIG. 3D illustrates a right side view of head member 102 and shows that the sensing array 300 can include a sixth camera 312 radially spaced from and positioned adjacent to the fifth camera 310 and the first camera 302 in the sensing array 300 and supported on the head member 102. Indeed, the first camera 302 can be radially spaced from and positioned adjacent to the sixth camera 312 in the sensing array 300 and supported on the head member 102.

Accordingly, as shown in FIGS. 3A-3D, a plurality of cameras can be radially spaced around the perimeter of a robot body member (e.g., the head member 102). In the configuration of sensing array 300, each camera of the array 300 can be positioned adjacent to two neighboring cameras. For example, the first camera 302 can be positioned between and adjacent to second and sixth cameras 304 and 312, the second camera 304 can be positioned between and adjacent to the first and third cameras 302 and 306, the third camera 306 can be positioned between and adjacent to the second and fourth cameras 304 and 308, the fourth camera 308 can be positioned between and adjacent to the third and fifth cameras 306 and 310, the fifth camera 310 can be positioned between and adjacent to the fourth and sixth cameras 308 and 312, and the sixth camera 312 can be positioned between and adjacent to the fifth and first camera 310 and 302.

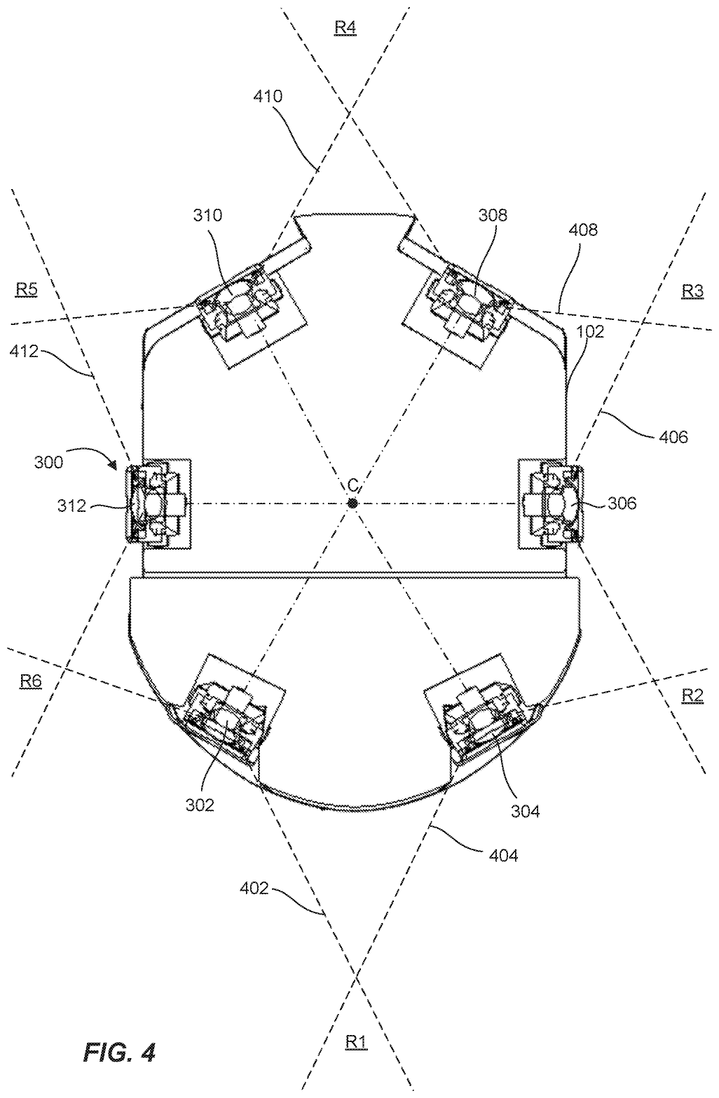

As shown, although not to be considered limiting in any way, each of the cameras in FIGS. 3A-3D can be positioned along a transverse plane T of the head member 102. FIG. 4 illustrates a cross-sectional top view of head member 102 and sensing array 300 taken along the transverse plane T of the head member 102. Each of first, second, third, fourth, fifth, and sixth cameras 302, 304, 306, 308, 310, and 312 are radially spaced about center C of head member 102. It is to be understood that the cameras being radially spaced about the center C of the head does not require that the cameras be the same distance from the center. In this disclosure, the terms “radially spaced” and “radially supported” should be understood to include any sensors spaced/supported about a center in any orientation and at any distance from the center. The sensors need not, although they can, be spaced about the center at the same distances or orientations with respect to each other and/or with respect to the center. Each of the cameras 302, 304, 306, 308, 310, and 312 respectively have a field of view 402, 404, 406, 408, 410, and 412 (shown in dashed lines from each camera) that shows the range of the field of view the in which the camera is able to capture physical phenomena in an environment when taking an image. It is to be appreciated that the fields of view in FIG. 4 are not necessarily indicative of actual fields of view of the cameras in array 300. The fields of view can be any field of view used in any cameras or imaging processes, and can be different (e.g., more narrow or wide) than what is shown. The field of view of each camera is not intended to be limited by this disclosure in anyway.

Furthermore, it is to be appreciated that, when utilizing sensors other than cameras that rely on sensing within a certain area, that the field of view can instead be described as a “field of sensing” of the sensor(s). The term “field of sensing,” as used herein, can refer to an area around a sensor in which the sensor is capable of capturing or picking up readings from any physical phenomena. In image sensors or other sensors that capture electromagnetic radiation, the field of sensing can be the field of view that is viewable by the image sensor to capture an image. In other sensors, such as audio sensors, magnetic sensors, radar sensors, time-of-flight sensors, depth measuring sensors, area mapping sensors, or any other sensors, the field of sensing refers to an area around the sensor in which physical phenomena can be measured or registered by the sensor. Accordingly, the fields of view 402, 404, 406, 408, 410, and 412, as well as any other fields of view described herein or shown in the figures, should be understood to broadly represent any fields of sensing for any sensor, and not just fields of view of an imaging sensor or camera.

Throughout the disclosure, the sensors and cameras may described as capturing data or capturing images. It will be appreciated by those skilled in the art that sensors and cameras capturing images or data involves a process in which the sensor or camera captures physical phenomena in an environment and outputs a signal indicative of the captured physical phenomena. The signal is then either processed onboard the sensor or sent to an outside processor or computer for processing, whereby the signal is processed into data that can be used for observation, display, analysis, and/or quantification of the physical phenomena in the environment. Furthermore, the data can be output as images, depth maps, or other informational aggregate data outputs that can be displayed to a user or used to facilitate operation of a system. For simplicity and convenience, the process undergone by each camera or sensor to generate an image or data may be omitted in the rest of the disclosure. Instead it may be simply said that an image sensor or camera “captures an image” or that a sensor “captures data” as short hand for the processes (e.g, capturing physical phenomena, outputting a signal, processing the signal to data) carried out by the sensors/cameras in order to be more concise in the disclosure. Accordingly, any reference to a camera, sensor, sensing array, and/or imaging array carrying out capturing and image, capturing data, imaging an environment, or performing a task or operation generically described as “to image,” “imaging”, “capture”, or “capturing” should be understood to include possibilities of sensing physical phenomena to create data by any sensor, not just taking images using an image sensor.

As described above, the sensing array 300 can comprise one or more cameras with overlapping fields of view. As illustrated in FIG. 4, which example configuration is not intended to be limiting in any way, each of the cameras can be positioned such that they share an amount of overlap in their fields of view with adjacent cameras. In other words, in this example, each of the cameras 302, 304, 306, 308, 310, and 312 in the sensing array 300 can have a field of view that overlaps with any adjacent camera in the sensing array 300. For example, the field of view 402 of the first camera 302 can overlap with the fields of view 404 and 412 of the second and sixth cameras 304 and 312. The field of view 404 of the second camera 304 can also overlap with the field of view 406 of the third camera 306. The field of view 406 of the third camera 306 can also overlap with the field of view 408 of the fourth camera 308. The field of view 408 of the fourth camera 308 can also overlap with the field of view 410 of the fifth camera 310. The field of view 410 of the fifth camera 310 can also overlap with the field of view 412 of the sixth camera 312. The field of view 412 of the sixth camera 312 can also overlap with the field of view 402 of the first camera 302.

R1 is an overlapping region for the fields of view 402 and 404 of the first and second cameras 302, 304. R2 is an overlapping region for the fields of view 404 and 406 of second and third cameras 304, 306. R3 is an overlapping region for the fields of view 406 and 408 of third and fourth cameras 306, 308. R4 is an overlapping region for the fields of view 408 and 410 of fourth and fifth cameras 308, 310. R5 is an overlapping region for the fields of view 410 and 412 of fifth and sixth cameras 310, 312. R6 is an overlapping region for the fields of view 412 and 402 of sixth and first cameras 312, 302. The overlapping regions R1, R2, R3, R4, R5, and R6 of the fields of view 402, 404, 406, 408, 410, and 412 of cameras 302, 304, 306, 308, 310, and 312 allow for the generation of individual images based on signals provided by each camera that can be combined or stitched together with images of adjacent cameras to produce a viewable 360 degree, or less than 360 degree, panoramic image that can be displayed to a user, as well as a stereo image that can be displayed to a user. Furthermore, the sensors or cameras can be used to generate images or data that can be processed to create distance or depth maps of the environment and objects sensed by the sensor array. Such depth maps can map an environment and provide a robot with information about distances, objects, positions, and other dimensional information about an environment. Such depth maps can be used to facilitate navigation of the robot around the environment without unintended collisions or damage to the robot. Such stereo images described herein can comprise two dimensional images presented to separate eyes of the user such that the user's brain can view the images and perceive depth, distance, and relative size of objects in the viewable stereo image.

It is to be appreciated that the examples herein are described in terms of cameras, images, and viewable stereo images. However, it is to be further understood that the cameras can be any kind of sensor, the images can be any kind of generated data that is generated based on signals provided by the sensors based on captured physical phenomena, and the viewable stereo images can be understood broadly as including data and observable stereo data elements, not just images.

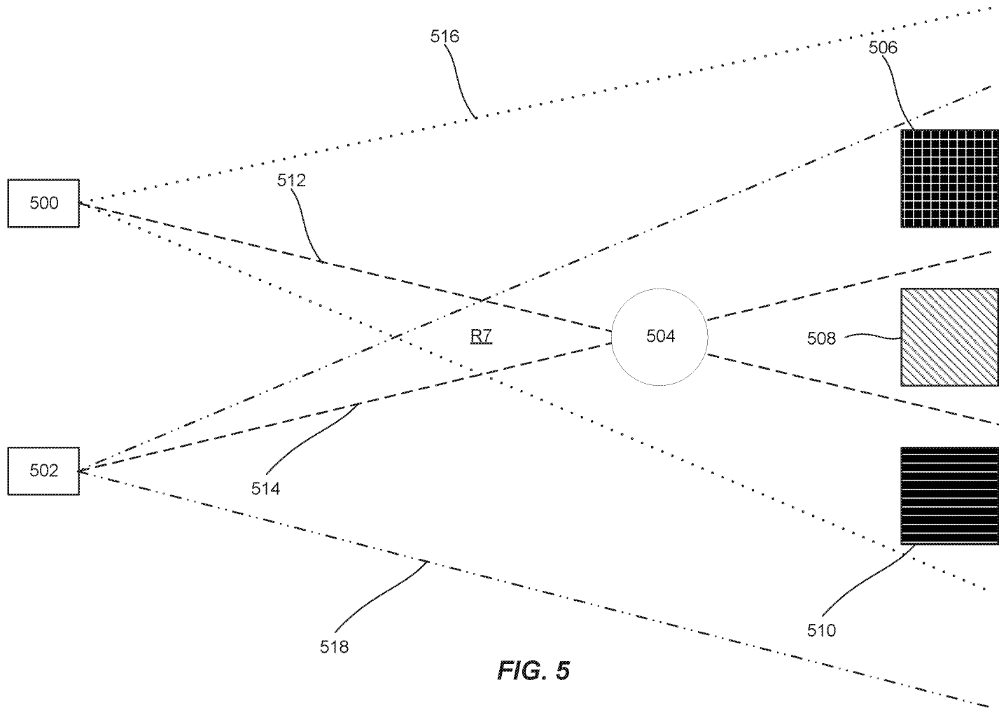

FIG. 5 illustrates an example of how stereopsis works and how stereo images are combined to create a three-dimensional effect for users viewing the stereo images. Stereopsis is a term that refers to perception of depth and three-dimensional structures in an image obtained on the basis of visual information deriving from two eyes by individuals with normally developed binocular vision. The perception of depth in a stereo image is produced by the reception in the brain of visual stimuli from both eyes at the same time. Stereopsis can be simulated for a person by having each eye of a human being presented with different images. Therefore stereopsis can be stimulated with two pictures, one for each eye. In addition or alternatively to using generated images to produce stereo images as an aggregate data output, the generated images of the cameras can also be stitched together to form stitched images that combine the fields of view of two or more images to create a 2D stitched image showing a larger view of an environment than is possible by an image generated based on a signal provided by a single camera. The larger view stitched image can allow a robot or a user of the robot to achieve a high level of situational awareness of the environment in which the robot operates, including even a 360 degree stitched image of the environment. Furthermore, images from stereo camera pairs can be directly displayed to eyes of the user to allow the user to see the surrounding environment, or, the images can be processed and used by algorithms and/or software codes to create quantitative 3D depth maps of the environment in which the robot operates including object locations, dimensions, distances and other factors to provide enhanced situational awareness to the robot as well as a user operating the robot. Such 3D depth maps can be used by controls, algorithms, software, and/or hardware of the robot to aid in autonomously, semi-autonomously, or manually operating/navigating the robot through a working environment that is mapped with the 3D depth map.

FIG. 5 illustrates a setup of a scene being imaged by two cameras, first camera 500 and second camera 502, which can be cameras within the sensing array 200 or 300 of the robot 100. The images taken are of an object 504 in the foreground being taken against a background including objects 506, 508, and 510, these being within the overlap region R7. As illustrated, a line of sight 512 within the field of view 516 of the first camera 500 causes the first camera 500 to view the object 504 at an angle such that the object 504, in an image generated based on a signal provided by the first camera 500, appears to be at a position somewhere between and in front of the objects 508 and 510. A line of sight 514 within the field of view 518 of the second camera 502 causes the second camera 502 to view the object 504 at an angle such that the object 504, in an image generated based on a signal provided by the second camera 502, appears to be at a position somewhere between and in front of the objects 506 and 508. In other words, due to the stereo overlap of the fields of view 516 and 518 for the cameras in region R7, an image generated based on a signal provided by the first camera 500 can be combined with an image generated based on a signal provided by the second camera 502 to produce a stereo image. Stereo overlap between imaging devices is required in order to produce stereo images because two views of the same scene must be used to create a stereopsis effect for a user and/or to create a quantitative three-dimensional (3D) depth map that in turn can be presented to human users of the system. Additionally, the images or 3D depth maps can be used by algorithms and related software and/or hardware implemented processes design to automate some functions of the systems (e.g. follow a prescribed trajectory, avoid a collision, interact with objects in the environment, etc.).

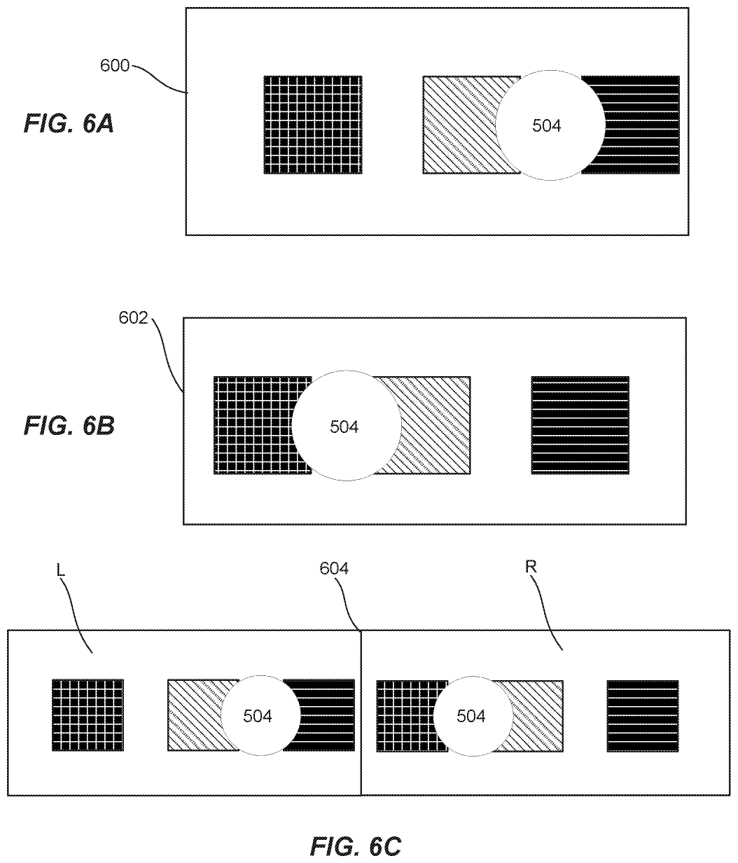

With reference to FIGS. 5 and 6A-6C, FIG. 6A illustrates an exemplary image 600 generated based on a signal provided by the first camera 500 of objects 504, 506, 508, and 510 that are within the overlap region R7. FIG. 6B illustrates an exemplary image 602 generated based on a signal provided by the second camera 502 of objects 504, 506, 508, and 510. Although images 600 and 602 are images of the same scene taken at the same time, the different angles and fields of view 516 and 518 from which cameras 500 and 502 capture the scene cause the object 504 to appear at different positions, or have a different parallax, with respect to objects 506, 508, and 510 of the background. Similarly, objects 506, 508, and 510 also appear at different locations within the scene for the images of both cameras.

Separate images 600 and 602 can be combined into a viewable stereo image 604 including both of the separate images 600 and 602 displayed together simultaneously to a user. The right portion R is shown only to the right eye of the user and the left portion L is shown only to the left eye of the user. Both the right portion R and the left portion L are shown simultaneously to the right and left eye of the user. When the images 600 and 602 with different parallax positions for object 504 within the scene are combined and shown separately to the right eye and left eye of the user, the brain of the user combines the images to a single viewed scene and gives apparent depth to object 504 within the scene. Although in reality the user is merely being shown two dimensional images, the brain interprets three-dimensional information and depth information from the images due to the difference in parallax for object 504 in the images 600 and 602. The overlapping images 600 and 602 received from the cameras can be used to create/compute a 3D depth map of an environment in which the robot is operating. The 3D depth map, along with the 2D images from the cameras, can be used by various algorithms and related software code to allow the robot to perform various operations (e.g. interacting with objects in the robot's workspace, avoiding collisions, moving along a defined path from a first point to a second point, or for various safety purposes).

The array 300, and other imaging systems disclosed herein, comprise two or more cameras having stereo overlap (e.g., overlap between different camera fields of view) with each other. For example, as described above, the field of view 402 of the first camera 302 shares an overlap region R1 with the field of view 404 of the second camera 404, and the field of view 404 of the second camera 304 also shares an overlap region R2 with the field of view 406 of the second camera 306. Accordingly, combined stereo images can be generated as aggregate data output from the separate images generated based on signals from the first and second cameras 302 and 304 based on physical phenomena captured in the overlapping region R1 by the first and second cameras 302 and 304, or from the separate images generated of the overlap region R2 based on signals provided by the second and third cameras 304 and 306. The sensing array 300 can be configured to generate an image based on a signal provided by the camera 304, generate an image based on a signal provided by the camera 302, and to facilitate combination of the generated images to produce a first viewable stereo image as an aggregate data output, such as, for example, image 604 in FIG. 6C. Furthermore, the sensing array 300 can be configured to generate the image based on the signal provided by the camera 304, generate an image based on the signal provided by the camera 306, and to facilitate combination of the generated images to produce a second viewable stereo image as an aggregate data output similar to image 604 in FIG. 6C. Additionally, the images generated based on signals provided by various cameras can be stitched together to create a high-resolution field of view image (whether stereo or non-stereo) as an aggregate data output that has a larger field of view than any individual images from individual cameras. The field of view images can be used, either alone or in conjunction with 3D depth maps, stereo images, 2D generated images or others, to allow an operator or user of the robot, and/or algorithms and software code to operate the robot autonomously and/or under supervised autonomy in an environment to enhance a user's and/or system's situational awareness in an environment.

With multiple cameras supported on head member 102, the sensing array 300 can capture physical phenomena and/or capture multiple different images or data in multiple different directions in an environment around the sensing array. For example, an image can be generated based on signals provided by each of the first, second, third, fourth, fifth, and sixth cameras 302, 304, 306, 308, 310, and 312. As shown in FIG. 4 each of the first, second, third, fourth, fifth, and sixth cameras 302, 304, 306, 308, 310, and 312 face in a different direction and include a field of view that has stereo overlap with two neighboring cameras (e.g., first camera 302 has stereo overlap with both second camera 304 and sixth camera 312). Any two generated images of the first, second, third, fourth, fifth, and sixth cameras 302, 304, 306, 308, 310, and 312 that have stereo overlap with each other can be combined to generate a viewable stereo image. If all six cameras provide signals to generate images, each image can be combined with an image of a neighboring camera to produce a viewable stereo image or panoramic image as an aggregate data output (e.g., stereo images can be generated from each combination of camera images by combining images from the first and second cameras, the second and third cameras, the third and fourth cameras, the fourth and fifth cameras, the fifth and sixth cameras, and the sixth and first cameras). Images of any combinations of subsets or all of the cameras can be used, as described elsewhere herein, to create 3D depth maps of an environment and/or to create large field of view images of a workspace in which the robot operates.

As shown, the first, second, third, fourth, fifth, and sixth cameras 302, 304, 306, 308, 310, and 312 are spaced from each other radially and are spaced around all 360 degrees of the head member 102. Accordingly, the sensing array 300 can sense 360 degrees all around the robot 100. By combining individual images of the first, second, third, fourth, fifth, and sixth cameras 302, 304, 306, 308, 310, and 312 into multiple viewable stereo images, the entire 360 degree perimeter around the head member 102 is imaged.

Furthermore, the multiple stereo images can be stitched together to form a viewable stereo field of view image that shows the environment around the robot 100 in a 360 degree image to facilitate a user being able to view anywhere around the robot that they desire with the stereo image. The multiple stereo images, the stitched together viewable stereo filed of view image, or both, can be viewed by the user or an operator on a display device, such as via a head mounted display device (more particularly an augmented and/or virtual reality display device) capable of displaying images to both a right and left eye of a user. The head mounted display may include rotational sensors, gravitational sensors, line of sight sensors, eye position sensors, or others for sensing a direction in which a user is looking in order to display the field of view image to the user at a position corresponding to a direction in which the user is looking.

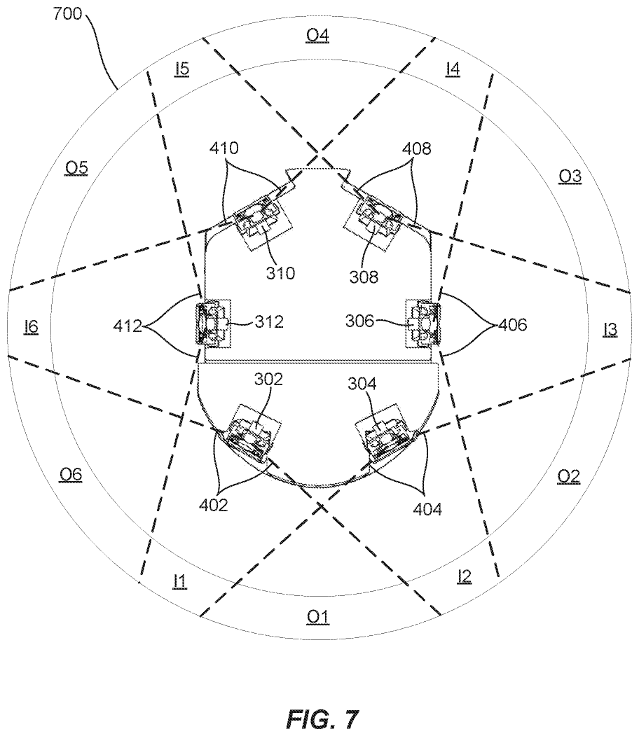

FIG. 7 illustrates an example of combining or stitching separate images together to form a viewable, stitched-together or stereo field of view image 700. As illustrated in FIG. 7, each of the cameras 302, 304, 306, 308, 310, and 312 are disposed on the robot to facilitate generation of an image corresponding to the cameras field of view. The first camera 302 can be operable to facilitate generation of a first image I1, the second camera 304 can be operable to facilitate generation of a second image I2, the third camera 306 can be operable to facilitate generation of a third image I3, the fourth camera 308 can be operable to facilitate generation of a fourth image I4, the fifth camera 310 can be operable to facilitate generation of a fifth image I5, and the sixth camera 312 can be operable to facilitate generation of a sixth image I6.

Each of the images (e.g., I1, I2, I3, I4, I5, and I6) can be generated by generating data from one or more signals output by the corresponding camera. For example, the first camera 302 (in other words, first sensor) can capture physical phenomena in the environment around the robot that is within the field of view 402 (in other words, field of sensing) of the first camera 302. The first camera 302 can then output one or more signals indicative of the physical phenomena captured in the field of view 402. The one or more signals can then be processed by a processor (whether on board or off board with the first camera 302) to generate first data indicative of the captured physical phenomena. The images I2, I3, I4, I5, and I6 can be captured in the same manner from each of the corresponding cameras 304, 306, 308, 310, and 312.

Each image (e.g., I1, I2, I3, I4, I5, and I6) can include overlapping regions where the field of view (or field of sensing) of the camera overlaps with a field of view of another camera. For example, overlapping region O1 represents a region where the fields of view of cameras 302 and 304 overlap, overlapping region O2 represents a region where the fields of view of cameras 304 and 306 overlap, overlapping region O3 represents a region where the fields of view of cameras 306 and 308 overlap, overlapping region O4 represents a region where the fields of view of cameras 308 and 310 overlap, overlapping region O5 represents a region where the fields of view of cameras 310 and 312 overlap, and overlapping region O6 represents a region where the fields of view of cameras 312 and 302 overlap. Image I1 based on the signal provided by the first camera can include the regions in FIG. 7 marked as I1, O1, and O6. Image I2 can include regions I2, O1, and O2; image I3 can include regions I3, O2, and O3; image I4 can include regions I4, O3, and O4; image I5 can include regions I5, O4, and O5; and image I6 can include regions I6, O5, and O6.

As described above, each image I1, I2, I3, I4, I5, and I6 can be combined with neighboring images to create stitched-together images or viewable stereo images, such as the example stereo image 604 of FIG. 6C. Or in other words, data generated based on signals by the corresponding sensors can be combined into an aggregate data output (e.g., audio map, depth map, panoramic 2D image, stereo 3D image, or any other desired output based on the gathered physical phenomena. For example, image I1 can be combined with image I2 to form an aggregate data output in the form of a first stereo image SI1, image I2 can be combined with image I3 to form an aggregate data output in the form of a second stereo image SI2, image I3 can be combined with image I4 to form an aggregate data output in the form of a third stereo image SI3, image I4 can be combined with image I5 to form an aggregate data output in the form of a fourth stereo image SI4, image I5 can be combined with image I6 to form an aggregate data output in the form of a fifth stereo image SI5, and image I6 can be combined with image I1 to form an aggregate data output in the form of a sixth stereo image SI6. As with images I1 through I6, stereo images SI1 through S6 can each include multiple regions shown in FIG. 7 for each stereo image, such as stereo image SI1 (i.e., regions O6, I1, O1, I2, and O2), stereo image SI2 (i.e., regions O1, I2, O2, I3, and O3), stereo image SI3 (i.e., regions O2, I3, O3, I4, and O4), stereo image SI4 (i.e., regions O3, I4, O4, I5, and O5), stereo image SI5 (i.e., regions O4, I5, O5, I6, and O6), and stereo image SI6 (i.e., regions O5, I6, O6, I1, and O1).

With all stereo images SI1 through SI6 formed, the images can cover a view of 360 degrees around the robot. Using image stitching, stereo images SI1 through SI6 can be stitched together to form a single, continuous, 360 degree, panoramic, and/or stereo field of view image 700 as shown in FIG. 7. The generated field of view image is displayable on a display that is capable of displaying viewable stereo images to a user (e.g., head-mounted display, augmented reality display, virtual reality display, monitor, projector, or other display) to be viewed by a user. Due to limitations in a human field of view (i.e., humans are not capable of viewing 360 degrees at one time), not all of the image 700 may be viewed simultaneously. A user may use a user interface and computer programming and execution to control and direct which angle and portion of image 700 is viewed at a given time. Furthermore, when using an augmented reality, virtual reality, or head/eye tracking display, the view of image 700 may be automated based on head-tracking of the user or eye/retina/line of sight tracking of the user. In other words, as a user moves their head or eyes in a virtual environment to view different angles or views of the 360 degree environment, the display can rotate and translate the displayed image to display a view to the user based on where the user is looking within the defined virtual environment at a given point of time.

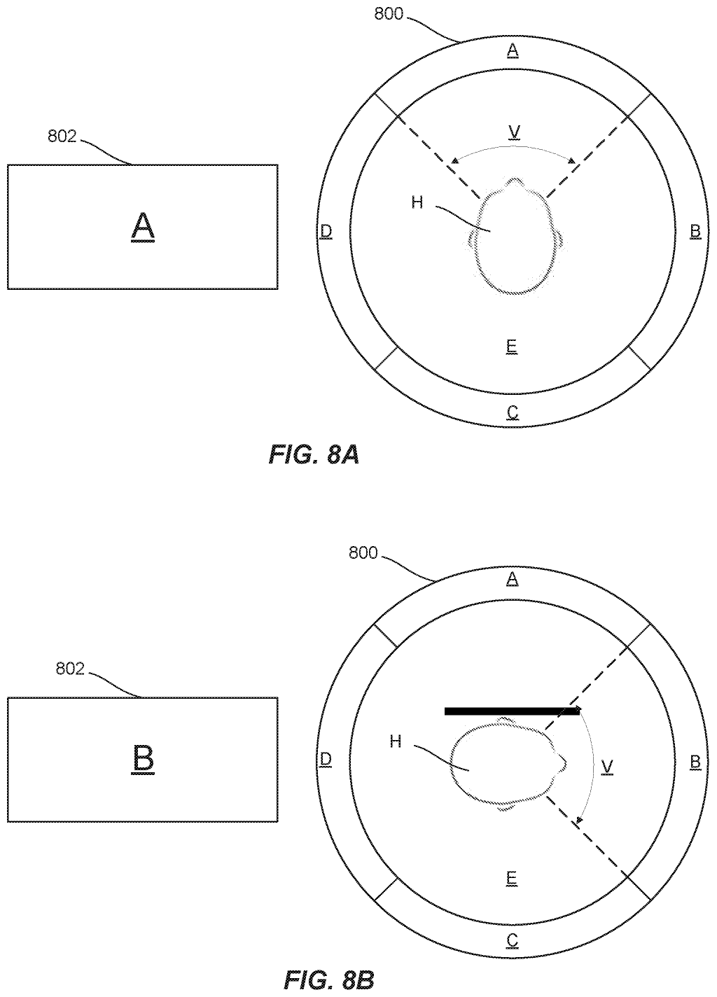

FIGS. 8A and 8B illustrate movement of a head H wearing a display device within an environment E and illustrate what portion of viewable stereo image 800 is displayed in display view 802 based on the orientation of the user's head within the environment E. It is to be understood that, while viewable stereo image 800 is not a physical presence within environment E, the virtual orientation and positional relationship of viewable stereo image 800 within environment E is illustrated in FIGS. 8A and 8B.

In FIG. 8A, head H is positioned within the environment E such that the field of view V of the head H is oriented toward portion A of viewable stereo image 800. As such, portion A is viewable as a displayed image on display view 802 of a display showing images to the user. Viewable stereo image 800 further includes portions B, C, and D. As shown in FIG. 8B, the user has rotated their head within the environment E to orient the head toward portion B of viewable stereo image 800 within the environment E. Due to the movement of the head H of the user, the display showing viewable stereo image 800 now displays portion B viewable as a displayed image on display view 802 of a display showing images to the user.

With sensors/cameras disposed in a sensing array around an outer perimeter of the robot 100 (e.g., around the head member 102), it is to be appreciated that the robot 100 is capable of imaging either a partial arc or a complete 360 degree field of view around the robot 100. Because of the expansive imaging range of the sensing array of the robot 100, the robot member supporting the cameras need not be movable to display a radial field of view to a user. For example, with the sensing array of cameras supported on the head member 102 of the robot 100, and with the sensing array of cameras being able to image 360 degrees around the robot 100, the head member 102 of the robot 100 can image an entire 360 degree field of view without the need of moving or rotating the head through the arc for the field of view to generate the image. Stated differently, the sensing array shown and discussed herein allows the head member 102 of the robot 100 to be supported in a fixed position relative to the upper torso robot body member 106. As such, expensive systems, mechanisms, etc. that include various rotatable structural members, joints, actuators, and other components that would otherwise facilitate the head member 102 to be rotatable and moveable relative to the upper torso robot body member 106 and the resulting degrees of freedom can be eliminated. Indeed, many prior humanoid robots comprise limited sensing setups, thus requiring a moveable head member and means for actuating the rotation of the head member in order to move the sensors to image various portions of an environment in which the robot is operating.

The robot body member (e.g., the robot head member) can remain in a stationary state and still provide a 360 degree viewable field of view image to a user viewing the field of view on a display. Accordingly, the imaging array(s) described herein are operable to generate multiple images showing different directions around a sensing array based on signals from multiple sensors and to facilitate combination of the generated multiple images to produce multiple viewable stereo images, panoramic images, depth maps, and/or others, all while the robot body member supporting the cameras remains in a stationary state. This can facilitate simplifying the design of the robot by eliminating degrees of freedom and allowing multi directional imaging using camera arrays disposed on stationary robot body members. Although, it is still to be appreciated that the robot arrays as taught herein are entirely able to function on a moving robot body member as well as a stationary body member. Although a body member including an array can be capable of moving, the body member is not required to move to generate multiple images in multiple directions, including multiple viewable stereo images, 360 degree images, 3D depth maps, stitched images, field of view images. As stated elsewhere, the various images captured, combined, generated, and/or processed can be used advantageously to facilitate causing the robotic system to (i) operate autonomously and/or under supervised autonomy; and/or (ii) to enhance the operators and/or system's situational awareness of the workspace environment in which the robot is operating; and/or (iii) to allow algorithms and related software code to implement assisted modes of operation, such as to automatically prevent the robot from accessing part of the workspace environment (e.g. in the event that such access could create hazardous conditions), to prevent collision with objects and/or personnel that may be operating in proximity of the robot, to allow the robot to interact with objects in the environment, to allow the robot to navigate from one point to another along a prescribed path, or any other operations used in an autonomous, semi-autonomous, or user-controlled robot.

Furthermore, the head member of the robot need not move in order to simulate movement of the head to a user viewing the field of view image. For example, the robot can stand still and stationary within an environment E and capture a 360 field of view of the environment. A user viewing the field of view image on a display can use a user interface and/or user controls with computer programming/execution to manipulate the display and rotate a view through the entire 360 degree field of view image without the robot ever moving the head member or rotating within the environment. This rotation of the field of view image can simulate the rotation of the robot head member to the user without actual rotation of the head member being necessary.

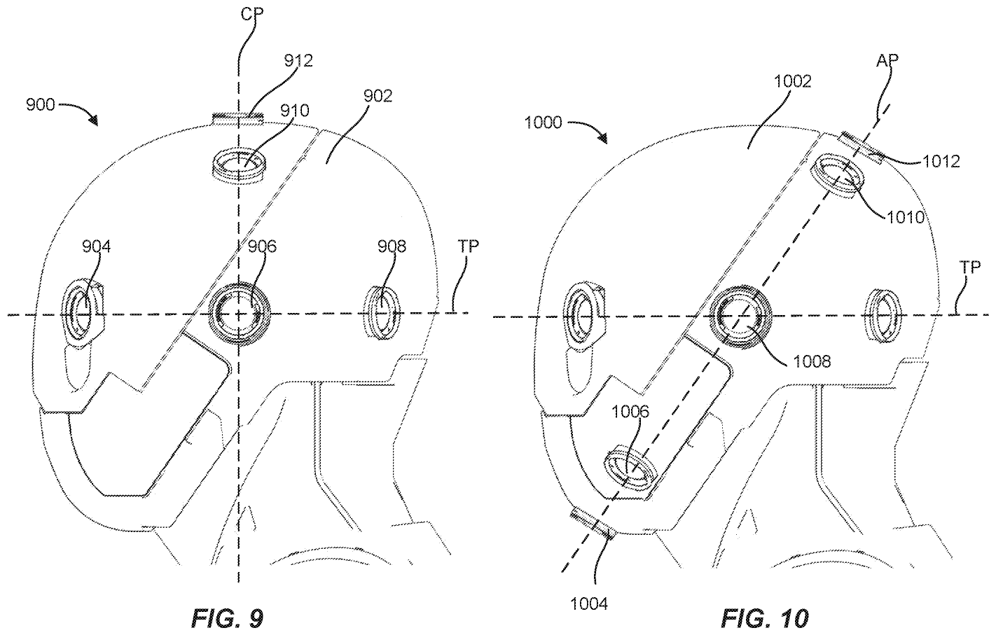

This disclosure is not limited to disposing sensors on the transverse plane of a head member. Several different configurations are within the scope of the disclosure. The number of sensors and positioning of the sensors is not meant to be limited by the disclosure. For example, FIG. 9 illustrates a configuration where a plurality of cameras (e.g., cameras 904, 906, and 908) can be supported on head member 902 of the robot 900 on a common transverse plane T of the head member 902. Additionally, a plurality of cameras (e.g., cameras 906, 910, and 912) can be disposed along a common coronal plane CP of the head member 902.

Additionally, as shown in FIG. 10, a plurality of cameras (e.g., 1004, 1006, 1008, 1010, 1012) can be supported on head member 1002 of the robot 1000 along a common angularly oriented plane AP of the head member 1002 and the transvers plane TP. The angularly oriented plane AP can be oriented along a different orientation than the angle that is shown in FIG. 10. The disclosure is not intended to limit the angle of angularly oriented plane AP in any way. The cameras can be disposed on any plane at any angle of the head member 1002.

In another example, the robot body member (e.g., the head member of the robot) can comprise a sensing array having cameras disposed on any one of a transverse/horizontal plane, a coronal plane/frontal, a sagittal/parasagittal plane, angularly oriented plane, or any combination of these to facilitate the sensing array being operable to capture physical phenomena in multiple different directions in an environment around the sensing array to facilitate generating images and/or data based on signals output by the sensors and/or cameras.

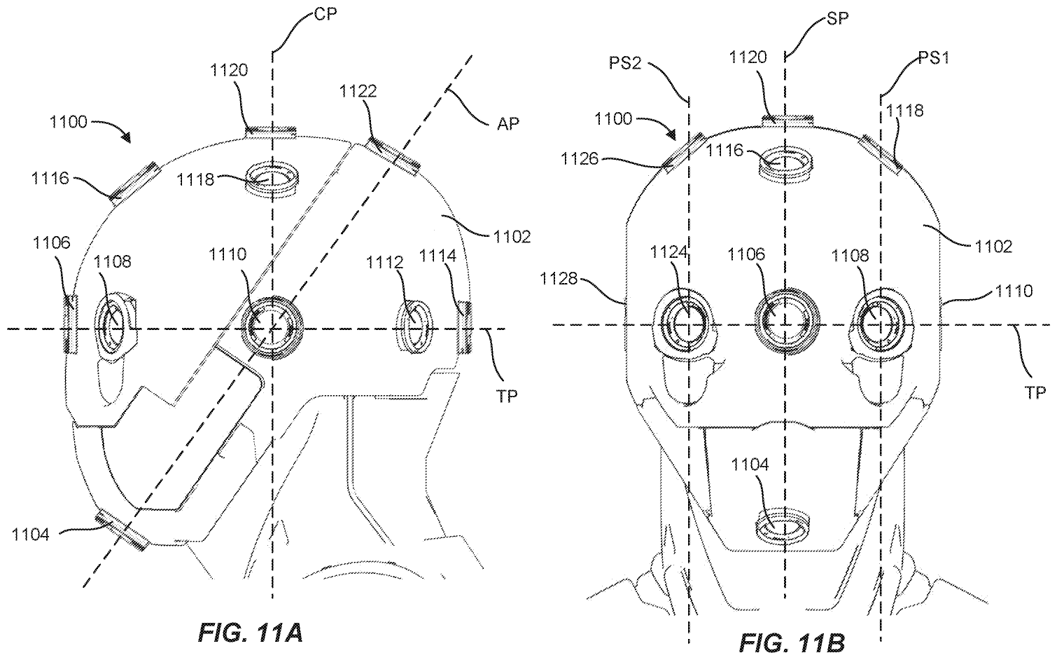

FIGS. 11A and 11B illustrate that a plurality of cameras can be supported on the head member 1102 of the robot 1100 along a plurality of planes of the head member 1102. For example, a plurality of cameras (cameras 1104, 1106, 1116, 1120, 1122, and 1114) can be supported on the head member 1102 on the sagittal plane SP of the head member 1102. A plurality of cameras (cameras 1104, 1110, 1122, and 1128) can be supported on the head member 1102 on the angularly oriented plane AP of the head member 1102. A plurality of cameras (at least cameras 1106, 1108, 1110, 1112, 1114, and 1128) can be supported on the head member 1102 on the transverse plane TP of the head member 1102. A plurality of cameras (at least cameras 1110, 1118, 1120, 1126, and 1128) can be supported on the head member 1102 on the coronal plane CP of the head member 1102. Additionally, a plurality of cameras (at least cameras 1108, 1118, 1112) can be supported on the head member 1102 on the first parasagittal plane PS1 of the head member 1102, and/or a plurality of cameras (at least cameras 1124 and 1126) can be supported on the head member 1102 on the first parasagittal plane PS2 of the head member 1102.

Any configuration and combination of cameras supported on the head member 1102 are within the scope of this disclosure. Pluralities of cameras can be disposed along one plane (e.g., the coronal, angled, sagittal, transverse, first parasagittal, or second parasagittal plane) of the head member 1102 or along a plurality of planes (e.g., two or more of the coronal, angled, sagittal, transverse, first parasagittal, and/or second parasagittal plane) on the head member 1102.

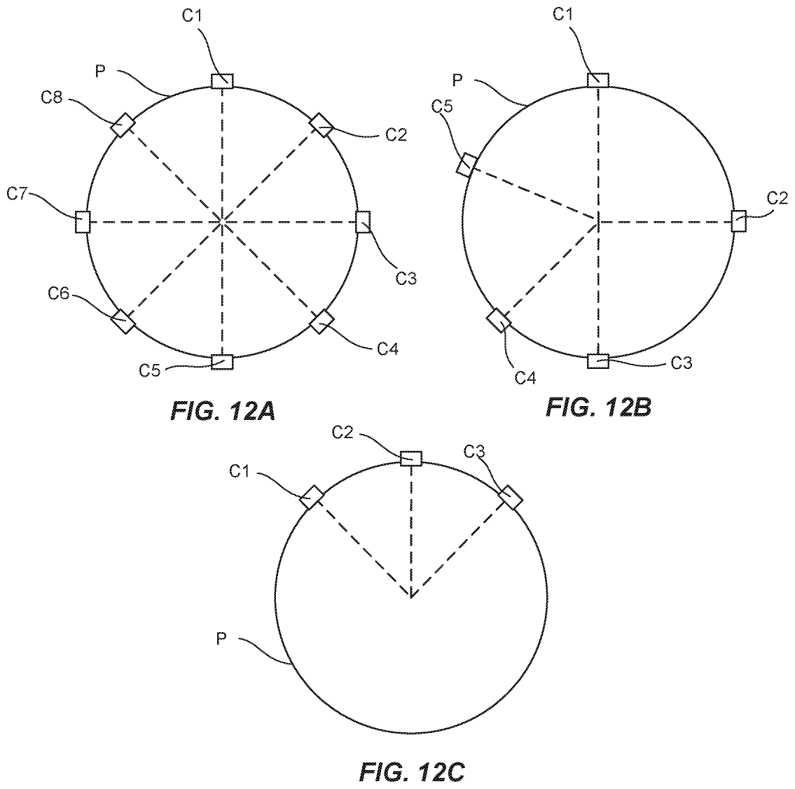

FIGS. 12A, 12B, and 12C illustrate schematic diagrams of various configurations and locations of cameras on a plane P. The plane P is an example of any plane (e.g., sagittal, parasagittal, coronal, transverse, angled, or other planes) on a robot body member that supports cameras. As illustrated in FIG. 12A, a plurality of cameras (e.g., cameras C1-C8) may be radially spaced around the plane P at equal angular distances from each other, or they may be offset at unequal angular distances. In the example shown, the plurality of cameras on the robot body member can be spaced an equidistance from each other on the robot body member of the robot. The angle at which the cameras are radially spaced around the plane P is not intended to be limited by this disclosure in anyway. As further illustrated in FIG. 12A, the plurality of cameras can be radially spaced around the plane P of the robot to achieve 360 degree imaging coverage. The cameras may be spaced at a distance and with fields of view that simulate human vision (e.g., approximately a 135 degree vertical field of view for a single eye, with a binocular stereo field of view of approximately 120 degrees and a combined field of view (i.e. combined stereo and monocular field of view) using both eyes of approximately 200 degrees horizontally) and may be spaced apart at locations simulating human eyes.

As illustrated in FIG. 12B, the plurality of cameras C1-C5 are spaced around plane P with different angles between one or more cameras. The cameras need not be equidistant from each other. The cameras can be disposed on the plane P to have a different angle between each pair of cameras. Alternatively, one or more cameras can be disposed at a different angle with respect to other cameras, or one or more cameras can be disposed at same angles with one or more other cameras. This disclosure is not intended to limit the angle measurements between cameras in anyway.

As illustrated in FIG. 12C, the plurality of cameras (e.g., cameras C1-C3) can be disposed around the plane P to only cover a partial arc of imaging. In other words, the plurality of cameras can be radially-spaced around the robot to achieve less than 360 degree imaging coverage. Additionally, while the cameras can be disposed to achieve 360 degree imaging coverage as in FIG. 12A, all cameras do not necessarily need to be operated simultaneously when capturing physical phenomena of an environment.

The cameras can be selectively operated to capture only portions of the 360 degree imaging range. A first combination of fewer than all of the plurality of cameras, but at least two cameras of the plurality of cameras (e.g., C1-C8 of FIG. 1), can be selectively operated to capture physical phenomena to generate respective images of a first viewable region that is viewable by the first combination of cameras. Other cameras that are not within the first combination can be left dormant or non-functional during operation of the first combination of cameras. For example, cameras C1 and C2 of FIG. 12A can be selectively operated to generate images of respective fields of view of the camera C1 and the camera C2 to generate multiple images in different directions. The array of cameras therefore facilitate combination of the generated multiple images and generation of a field of view image as an aggregate data output corresponding to the field of view of the first combination of the plurality of cameras. The combined fields of view of cameras C1 and C2 that are imaged can comprise a first viewable region which can be displayed in a first field of view image to the user.

Furthermore, at least a second combination of fewer than all of the plurality of cameras, but at least two cameras of the plurality of cameras, can be selectively operated to capture respective images of a second viewable region of the environment different from the first viewable region and that is viewable by the second combination of cameras. For example, cameras C5 and C6 of FIG. 12A can be selectively operated to generate images of respective fields of view of the camera C5 and the camera C6. The combined fields of view of cameras C5 and C6 that are imaged can comprise a second viewable region. Any camera can be selectively operated with any other camera of the plurality of cameras. For example, camera C1 can be selectively operated with any of the remaining cameras C2 through C8, camera C2 can be selectively operated with any of the remaining cameras including C1 and/or C3 through C8, and so forth. Additionally, any number of cameras can be selectively operated together (e.g., two, three, four, five, or any number of cameras on the robot). Additionally, in robots with cameras disposed on multiple planes, cameras of different planes of any number can also be selectively operated together to generate images of a first viewable region to be displayed to a user.

As referenced elsewhere, the cameras of the arrays described herein can be replaced by, or supplemented with other sensors (e.g., audio sensing/recording devices, antennas, magnetometers, acoustic sensors, low frequency electromagnetic sensors, and others, or any of these in combination), positioned over a robot body member in a manner similar to the arrangement of cameras in any of the examples described herein. In some sensing modalities, such as acoustic and low frequency electromagnetic sensors, some information (e.g. position of a source, field gradient, and others) can be extracted not only by exploiting the overlapping “field of view”, but also from differences in phase of the sensed signal and/or a change in frequency in signal emitted and/or reflected from a “target/object” (e.g. doppler shift of a reflected acoustic wave by an object moving toward the sensor array) and the like.

As an example of an alternative or additional sensing array that can be used instead of or in conjunction with the imaging array, an audio sensing array for multidirectional audio sensing from a robot can be used and can include a plurality of microphone audio sensing devices radially supported on at least one or more robot body members of the robot. Similar to the combination of images described above, audio signals and audio data sensed by an array of microphones can be combined to produce an audio playback for a user that plays sounds in stereo back to a user in accordance with the position at which the sounds were recorded by the array. The sensed audio can be recorded and stored for subsequent playback. Additionally or alternatively, the sensed audio can be can processed (e.g., filtered, equalized, processed to create stereo etc.) and sent to an audio device, such as stereo headphones or an array of load speakers, of a system operator to provide substantially real-time audio information to the operator. The audio can be used by audio processing algorithms to detect the position (orientation and distance) of the source of sound or noise of interest in an environment in which the robot is operating. Accordingly, in a multi-speaker stereo system, sounds recorded by an array of microphones on a robot can be played to a user in stereo surround sound. Furthermore, the audio information can also be used to create 3D audio maps of an environment and objects contained therein to provide geolocation information of objects within the environment. Such audio maps can be used by controls, algorithms, software, and/or hardware of the robot to aid in autonomously, semi-autonomously, or manually operating/navigating the robot through a working environment that is mapped with the 3D depth map.

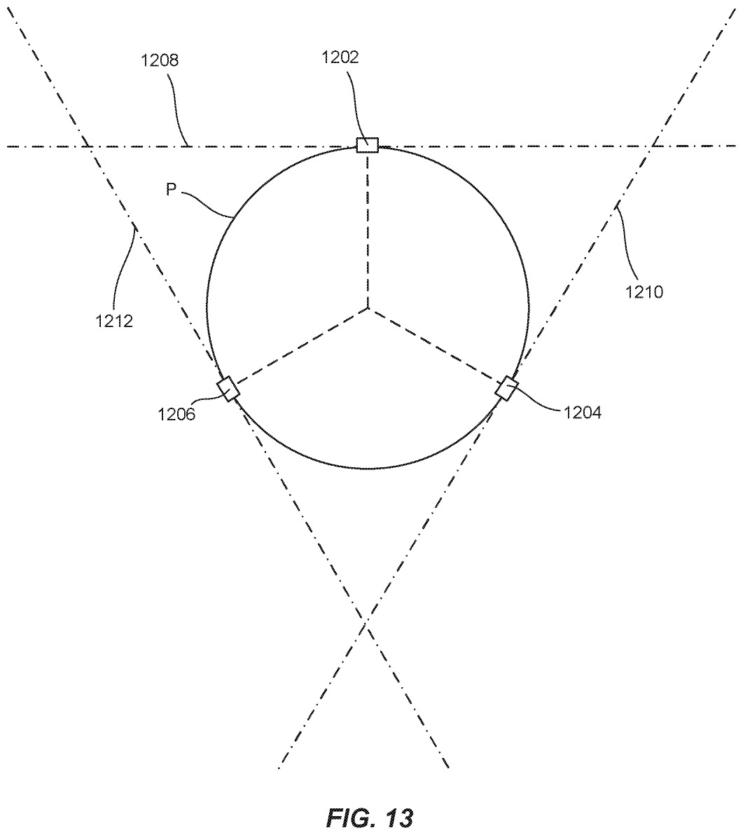

FIG. 13 illustrates a configuration to achieve 360 degree imaging around a robot. As shown cameras 1202, 1204, and 1206 are disposed on plane P at equal distances and radial angles from each other. The cameras 1202, 1204, and 1206 can include a field of view 1208, 1210, and 1212 respectively. As shown, the field of view of each camera 1202, 1204, and 1206 can be substantially 180 degrees with each field of view at least partially overlapping the fields of view of neighboring cameras. With the images of the three cameras 1202, 1204, and 1206 being stitched together, a 360 degree field of view image can be generated for the environment around a robot. Additional cameras can be spaced around plane P to provide more images for the field of view image to be generated from.

The disclosure is not intended to limit the size of fields of view of the cameras in any way. The fields of view of the cameras can be configured to any desired range or size. For stereo imaging, it is important that there be at least some overlap between fields of view of neighboring cameras. However, stereo overlap is not required if stereo imaging is not desired. For example two cameras having 180 degree fields of view can be located at opposite ends of the plane P and achieve 360 degree imaging. However the fields of view do not overlap and therefore cannot provide stereo imaging. Accordingly, for stereo imaging, it is preferable to include a number of cameras and sizes of fields of view to allow for stereo overlap between neighboring cameras in order to allow for stereo imaging 360 degrees around the robot.

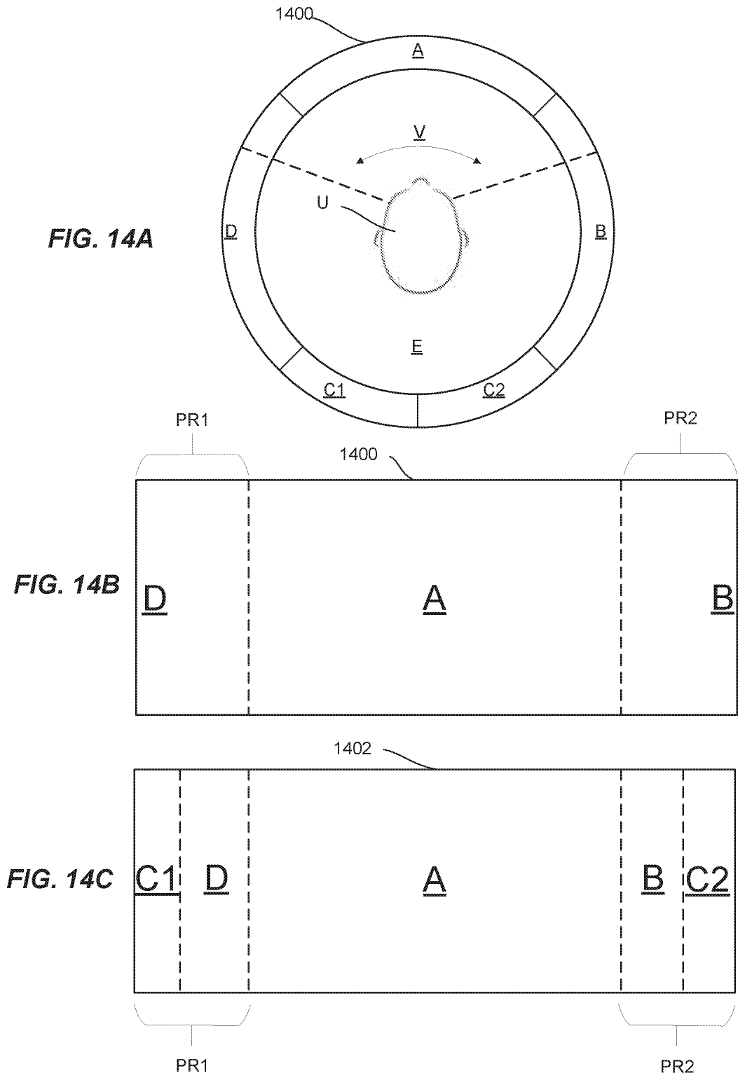

FIGS. 14A-14C illustrate configurations of displaying a field of view image to a user on a display device. FIG. 14A illustrates a configuration of a user U oriented to a 360 degree field of view image 1400 corresponding to an environment E. As shown, the user U is facing a region A of the field of view image 1400. Due to limitations on human's field of view, a human is only capable of viewing approximately a 135 degree vertical field of view for a single eye, with a binocular stereo field of view of approximately 120 degrees and a combined field of view (i.e. combined stereo and monocular field of view) using both eyes of approximately 200 degrees horizontal). Because the field of view image generated by a robot including and array described herein can cover 360 degrees, it is not possible for a human to view all 360 degrees of the field of view image without alterations being made to the field of view image. The robot or display device displaying an image to a user can alter the field of view image to allow the user to see more than 135 degrees of the field of view.

As shown in FIG. 14A, a human field of view V allows a user to only view region A of the field of view image 1400 as well as portions of regions D and B in a left peripheral region PR1 and a right peripheral region PR2 that represent the peripheral vision regions of the user. Most of regions D and B and all of region C are not viewable to the user U. FIG. 14B illustrates an image 1402 displayed on a display device to the user U based on the viewing orientation of the user U in FIG. 14A. As shown, displayed on the display device is all of region A and portions of regions D and B in peripheral regions PR1 and PR2. In order to allow the user U to view regions that are typically outside of the human field of view in the field of view image 1400, the image can be altered before being displayed on the display device.

As shown in FIG. 14C, the field of view image 1402 can be displayed to a user U on the display device such that up to all of the 360 degree field of view image 1400 is displayed to the user U in the approximately 135 degree field of view of the display device that is viewable by the user U. The field of view image remains unaltered in the A region so that the A region is displayed to the user U in an undistorted state. In addition, in the peripheral region PR1, the region D and region C1 are compressed in a length wise direction so that all of region D and region C1 can be displayed in the region PR1 of the display device. In other words, the roughly 90 degree field of view corresponding to region D and the roughly 45 degree field of view of region O1 are compressed to fit in a field of view (e.g., 22.5 degrees) smaller than the actual field of view of regions D and C1. In the peripheral region PR2, the region B and region C2 are compressed in a length wise direction so that all of region B and region C2 can be displayed in the region PR2 of the display device. In other words, the roughly 90 degree field of view corresponding to region B and the roughly 45 degree field of view of region C2 are compressed to fit in a field of view (e.g., 22.5 degrees) smaller than the actual field of view of regions B and C2. It is to be understood that the regions B, C1, C2, and D are shown in a distorted state due to the lengthwise compression of the regions. A computing device including a processor and memory storing instructions that can be executed by the processor can alter the displayed image displayed to the user based on the example images 1400 and 1402 shown in FIGS. 14A and 14B. While the user U cannot view the regions B, C1, C2, and D in an undistorted state, the user can at least be aware of movement or other events taking place in these regions even though they exist outside of the user's field of view, thus simulating peripheral vision of the user.

It will be appreciated that the entire field of view image 1400 need not be included in the altered field of view image 1402. For example, the alteration can omit regions C1 and C2 and display all of regions B and D in peripheral regions PR1 and PR2. This will increase the amount of image 1400 that the user is able to see and reduce the compression and distortion that must be performed on regions B and D when compared to field of view image 1402 of FIG. 14C.

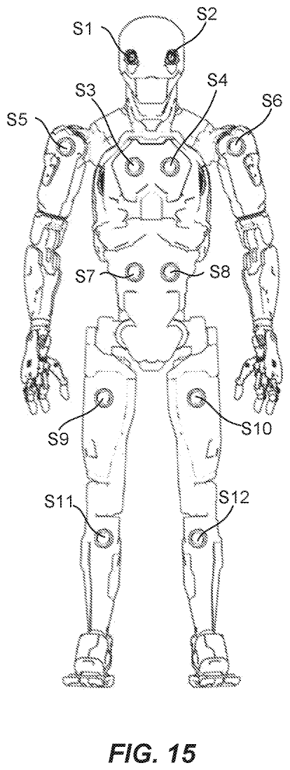

Above, it has been described that the sensors/cameras on a robot are placed on a head member of the robot. However, the location of the sensors on the robot are not intended to be limited in any way by this disclosure. As illustrated in FIG. 15, one or more sensors S1 through S12 can be supported on the robot at any position and on any body member (e.g., head, neck, shoulders, torso, chest, stomach, arms, legs, hands, feet, without limitation). Additionally, the sensors can be placed on any side of the robot including front, back, sides, top, and/or bottom, without limitation. Any combination of sensors can be supported on any combination of body members of the robot and on and around any plane of the robot. Accordingly, although the various sensors can be installed adjacent to each other on a single common support structure or body member (e.g., as shown in FIGS. 2-4, 7, and 9-13), the sensors could alternatively or additionally be installed on adjacent support structures and/or adjacent body members with known position and orientation relative to each other (e.g., as shown in FIG. 15). For example, the various sensors could be installed on adjacent limbs (e.g., arms, legs, hands, feet, torso, head, neck shoulders, hips, waist, or otherwise). As long as the orientations and positions of the various sensors is known and a portion of the sensed data is sensed by more than one sensor in the array, the sensed data from multiple sensors can be combined together as described herein, no matter which body members, limbs, or support structures of the robot the sensors are supported on.

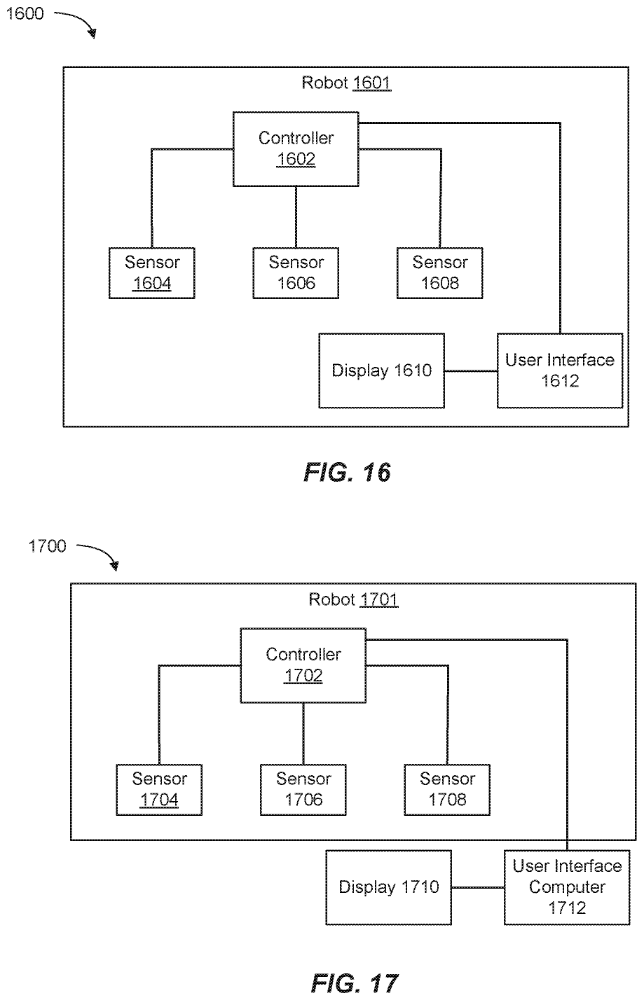

FIGS. 16 and 17 illustrate schematic diagrams of robotic systems according to examples of the current disclosure. FIG. 16 illustrates robotic system 1600 that can include a robot 1601. The robot can include a controller 1602 in communication with a plurality of sensors 1604, 1606, and 1608 supported on the robot 1601. The robot can further include a user interface 1612 and a display 1610 for displaying aggregate data outputs such as viewable stereo images and/or user interface info and generated sensor data to a user. Additionally, the controller 1602 can control the robot for autonomous or semi-autonomous movement about an operation environment using the data provided by the sensors 1604, 1606, and/or 1608. For example, the data from the sensors can be used to produce combined images, stereo images, depth maps, or other images that can be processed and used by algorithms or software stored in memory of the robot 1601 to allow the robot to avoid collisions with objects or personnel in an operating environment, avoid restricted areas, interact with objects, or to move about the environment. A robotic system 1600 can be a wearable exoskeleton worn and controlled by a human operator. Accordingly, the user interface 1612 and display 1610 can be disposed on-board the robot 1601 to provide access and controllability to the user wearing the robot 1601.

FIG. 17 illustrates a robotic system 1700 that can include a robot 1701. The robot can include a controller 1702 in communication with a plurality of sensors 1704, 1706, and 1708 supported on the robot 1701. In this configuration, the robot can be in network communication with a user interface computer 1712 and a display 1710 disposed remotely from the robot 1701. The controller 1702 can be in network communication with the user interface computer 1712 and the display 1710 by any wireless or wired form of network communication. The display may be a monitor, projector, head-mounted display device, augmented reality device, or virtual reality device. The user interface computer 1712 disposed remotely from the robot 1701 allows a user to teleoperate or remotely observe a teleoperated, autonomous, or remotely controlled robot. Additionally, the controller 1702 can control the robot for autonomous or semi-autonomous movement about an operation environment using the data provided by the sensors 1704, 1706, and/or 1708. For example, the data from the sensors can be used to produce combined images, stereo images, depth maps, or other images that can be processed and used by algorithms or software stored in memory of the robot 1701 to allow the robot to avoid collisions with objects or personnel in an operating environment, avoid restricted areas, interact with objects, or to move about the environment.

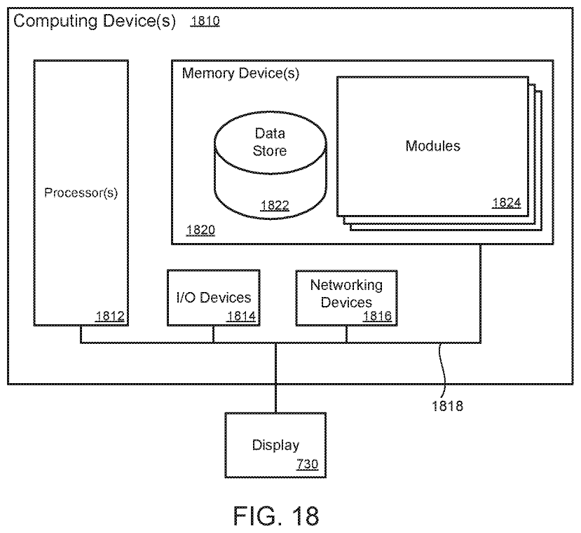

The controllers 1602, 1702, and the user interface computer 1712 can comprise a computing device such as a computing device 1810 illustrated in FIG. 18 on which modules of this technology may execute. The computing device 1810 is shown at a high-level and may be used as a main robotic controller and/or a controller for a robotic component. The computing device 1810 may include one or more processors 1812 that are in communication with memory devices 1820. The computing device 1810 may include a local communication interface 1818 for the components in the computing device. For example, the local communication interface 1818 may be a local data bus and/or any related address or control busses as may be desired.

The memory device 1820 may contain modules 1824 that are executable by the processor(s) 1812 and data for the modules 1824. In one example, the memory device 1820 can contain a main robotic controller module, a robotic component controller module, data distribution module, power distribution module, and other modules. The modules 1824 may execute the functions described earlier. A data store 1822 may also be located in the memory device 1820 for storing data related to the modules 1824 and other applications along with an operating system that is executable by the processor(s) 1812.

Other applications may also be stored in the memory device 1820 and may be executable by the processor(s) 1812. Components or modules discussed in this description that may be implemented in the form of software using high-level programming languages that are compiled, interpreted or executed using a hybrid of the methods.

The computing device 1810 may also have access to I/O (input/output) devices 1814 that are usable by the computing device 1810. In one example, the computing device 1810 may have access to a display 1830 to allow output of system notifications. Networking devices 1816 and similar communication devices may be included in the computing device. The networking devices 1816 may be wired or wireless networking devices that connect to the internet, a LAN, WAN, or other computing network.

The components or modules that are shown as being stored in the memory device 1820 may be executed by the processor(s) 1812. The term “executable” may mean a program file that is in a form that may be executed by a processor 1812. For example, a program in a higher-level language may be compiled into machine code in a format that may be loaded into a random-access portion of the memory device 1820 and executed by the processor 1812, or source code may be loaded by another executable program and interpreted to generate instructions in a random-access portion of the memory to be executed by a processor. The executable program may be stored in any portion or component of the memory device 1820. For example, the memory device 1820 may be random access memory (RAM), read only memory (ROM), flash memory, a solid-state drive, memory card, a hard drive, optical disk, floppy disk, magnetic tape, or any other memory components.

The processor 1812 may represent multiple processors and the memory device 1820 may represent multiple memory units that operate in parallel to the processing circuits. This may provide parallel processing channels for the processes and data in the system. The local communication interface 1818 may be used as a network to facilitate communication between any of the multiple processors and multiple memories. The local communication interface 1818 may use additional systems designed for coordinating communication such as load balancing, bulk data transfer and similar systems.

The functions described herein with respect to the array can be carried out by the computer systems and devices described herein. For example, the memory devices can store instructions that, when executed by the processor, can cause the robotic systems described herein to execute a method including steps of generating an image/data based on a signal output by the first camera/sensor, generating an image/data generated based on a signal provided by the second camera/sensor, combining the generated images/data of the first and second cameras/sensors to produce an aggregate data output comprising a stereo image/data or panoramic image based on the combined generated images/data of the first and second sensors.

The method can further include steps of generating an image/data based on a signal provided by the first camera/sensor, generating an image based on a signal provided by the second camera/sensor, combining the generated images/data of the first and second cameras/sensors to produce a first aggregate data output comprising a first stereo image/data based on the combined generated images/data of the first and second cameras/sensors. The method can further include steps of generating an image based on a signal provided by the first camera/sensor, generating an image/data based on a signal provided by the third camera/sensor, combining the generated images/data of the first and third cameras/sensors, and generating a second aggregate data output comprising a second stereo image/data based on the combined generated images of the first and third cameras/sensors.

The method can further include steps of selectively operating a first combination of at least two cameras/sensors of the plurality of cameras/sensors to generate respective images of a first viewable region viewable by the first combination of cameras/sensors, and selectively operating a second combination of at least two cameras/sensors of the plurality of cameras/sensors to generate respective images/data of a second viewable region different from the first viewable region and viewable by the second combination of cameras/sensors. The method can further include steps of generating images/data simultaneously from the first, second and third cameras/sensors to generate multiple images/data in different directions, and to facilitate combination of the generated multiple images/data to produce multiple aggregate data outputs comprising stereo images/data or other images or maps. The method may further comprise presenting a stereo image/data to the user via the head-mounted display device based on the generated images/data from the first and second cameras/sensors. The method may further comprise presenting a stereo image/data to the user via the head-mounted display device based on the generated images/data from the first and third cameras/sensors. The method can further include presenting a non-overlapping portion of at least one of the first or second images/data, combined with the stereo image/data to the user.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A robot sensing array for multidirectional sensing by a robot comprising one or more robot body members, the sensing array comprising:
a plurality of sensors radially supported on at least one of the one or more robot body members of the robot, the plurality of sensors comprising:
a first sensor;
a second sensor located on the at least one of the one or more robot body members at a first position adjacent to the first sensor; and
a third sensor located on the at least one of the one or more robot body members at a second position adjacent to the first sensor;
wherein the first sensor of the plurality of sensors is disposed to have an overlapping field of sensing with the second sensor and the third sensor.

2. The sensing array of claim 1, wherein the plurality of sensors of the sensing array are each mounted on a common robot body member of the one or more robot body members of the robot.

3. The sensing array of claim 2, wherein the common robot body member of the robot comprises a head member.

4. The sensing array of claim 2, wherein the plurality of sensors are spaced an equidistance from each other on the robot body member of the robot.

5. The sensing array of claim 1, wherein the sensing array is operable to capture physical phenomena in multiple different directions in an environment around the sensing array.

6. The sensing array of claim 1, wherein the plurality of sensors are disposed along a common transverse plane.

7. The sensing array of claim 6, wherein the sensing array is operable to capture physical phenomena in an environment around the sensing array in multiple different directions along the common transverse plane.

8. The sensing array of claim 1, wherein the plurality of sensors are disposed along a common sagittal plane.

9. The sensing array of claim 8, wherein the sensing array is operable to capture physical phenomena in an environment around the sensing array in multiple different directions along the common sagittal plane.

10. The sensing array of claim 1, wherein the plurality of sensors are disposed along a common coronal plane.

11. The sensing array of claim 10, wherein the sensing array is operable to capture physical phenomena in an environment around the sensing array in multiple different directions along the common coronal plane.

12. The sensing array of claim 1, wherein the plurality of sensors are disposed along a common angularly oriented plane.

13. The sensing array of claim 12, wherein the sensing array is operable to capture physical phenomena in an environment around the sensing array in multiple different directions along the common angularly oriented plane.

14. The sensing array of claim 1, wherein the plurality of sensors are radially spaced around the robot to achieve less than 360 degree sensing coverage.

15. The sensing array of claim 1, wherein the plurality of sensors are radially spaced around the robot to achieve 360 degree sensing coverage.

16. The sensing array of claim 1, wherein the plurality of sensors are disposed about the robot body member at a plurality of different radial positions.

17. The sensing array of claim 1, wherein the robot comprises at least one of a humanoid robot, a tele-operated robot, an exoskeleton robot, a legged robot, or a unmanned ground vehicle.

18. The sensing array of claim 1, wherein the plurality of sensors comprise one or more of:
a monochromatic image sensor;
an RGB image sensor;
a stereo camera;
a LIDAR sensor;
an RGBD image sensor;
a global shutter image sensor;
a rolling shutter image sensor;
a RADAR sensor;
an ultrasonic-based sensor;
an interferometric image sensor;
an image sensor configured to image electromagnetic radiation outside of a visible range of the electromagnetic spectrum including one or more of ultraviolet and infrared electromagnetic radiation; and
a structured light sensor.

19. The sensing array of claim 1, wherein the robot sensing array is an imaging array for facilitating multidirectional imaging by the robot,
wherein the first sensor is a first camera, the second sensor is a second camera, and the third sensor is a third camera.

20. The sensing array of claim 1, wherein the robot sensing array is an audio sensing array for facilitating multidirectional audio sensing by the robot,
wherein the first sensor is a first microphone, the second sensor is a second microphone, and the third sensor is a third microphone.

21. A robotic system for multidirectional sensing comprising:
a robot comprising one or more body members;
a sensing array mounted to the one or more body members of the robot, the sensing array comprising:
a plurality of sensors radially supported on at least one of the one or more robot body members of the robot, the plurality of sensors comprising:
a first sensor;
a second sensor located on the at least one of the one or more robot body members at a first position adjacent to the first sensor; and
a third sensor located on the at least one of the one or more robot body members at a second position adjacent to the first sensor;
wherein the first sensor of the plurality of sensors is disposed to have an overlapping field of sensing with the second sensor and the third sensor.

22. The robotic system of claim 21, further comprising:
at least one processor;
a memory device including instructions that are executable by the at least one processor.

23. The robotic system of claim 22, wherein the instructions, when executed by the at least one processor, cause the robotic system to:
generate first data from a signal output by the first sensor, generate second data from a signal output by the second sensor, and to combine the generated first and second data to produce a first aggregate data output; and
generate third data from a signal output by the third sensor, and to combine the generated first and third data to produce a second aggregate data output.

24. The robotic system of claim 22, wherein the instructions, when executed by the processor, control the robotic system to:
generate data from signals output by a first combination of sensors comprising at least two sensors of the plurality of sensors to generate data of a first region covered by a field of sensing of the first combination of sensors; and
generate data from signals output by a second combination of sensors comprising at least two sensors of the plurality of sensors to generate respective data of a second viewable region different from the first viewable region and covered by a field of sensing of the second combination of sensors.

25. The robotic system of claim 22, wherein the instructions, when executed by the processor, control the robotic system to:
generate data simultaneously from signals output by the first, second, and third sensors and to combine the generated data to produce an aggregate data output.

26. The robotic system of claim 22, wherein the plurality of sensors comprise one or more depth or imaging sensors; and
wherein one or more of the first aggregate data output and the second aggregate data output comprise a first 3D depth map of an environment used by the robot to navigate the environment.

27. The robotic system of claim 22, wherein the plurality of sensors comprise one or more audio or geolocation sensors; and
wherein one or more of the first aggregate data output and the second aggregate data output comprise a first audio map used by the robot to navigate the environment.

28. The robotic system of claim 23, wherein the plurality of sensors comprise a plurality of cameras.

29. The robotic system of claim 28, wherein the first aggregate output is a first stereo image and the second aggregate output is a second stereo image.

30. The robotic system of claim 28, wherein the first aggregate output is a first stitched image and the second aggregate output is a second stitched image.

31. The robotic system of claim 28,
wherein the memory device includes instructions that, when executed by the at least one processor, cause the robotic system to:
generate data from signals output by a first combination of at least two cameras of the plurality of cameras to generate data of a first viewable region covered by the fields of view of the first combination of cameras; and
generate data from signals output by a second combination of at least two cameras of the plurality of cameras to generate respective images of a second viewable region different from the first viewable region and covered by the fields of view of the second combination of cameras.

32. The robotic system of claim 28, wherein the instructions, when executed by the processor, control the robotic system to:
generate data simultaneously from signals output by the first, second, and third cameras and to combine the generated data to produce an aggregate data output.

33. The robotic system of claim 21, wherein the plurality of sensors of the sensing array are each mounted on a common robot body member of the plurality of robot body members of the robot.

34. The robotic system of claim 21, wherein the common robot body member of the robot comprises a head member.

35. The robotic system of claim 21, wherein the plurality of sensors are radially spaced around the robot to achieve less than 360 degree sensing coverage.

36. The robotic system of claim 21, wherein the plurality of sensors are radially spaced around the robot to achieve 360 degree sensing coverage.

37. The robotic system of claim 21, wherein the plurality of sensors are spaced an equidistance from each other on the robot body member of the robot.

38. The robotic system of claim 21, wherein the sensing array is operable to capture physical phenomena in multiple different directions in an environment around the robot.

39. The robotic system of claim 21, wherein the plurality of sensors are disposed along a common transverse plane.

40. The robotic system of claim 39, wherein the sensing array is operable to capture physical phenomena in an environment around the robot in multiple different directions along the common transverse plane.

41. The robotic system of claim 21, wherein the plurality of sensors are disposed along a common sagittal plane.

42. The robotic system of claim 41, wherein the sensing array is operable to capture physical phenomena in an environment around the robot in multiple different directions along the common sagittal plane.

43. The robotic system of claim 21, wherein the plurality of sensors are disposed along a common coronal plane.

44. The robotic system of claim 43, wherein the sensing array is operable to capture physical phenomena in an environment around the robot in multiple different directions along the common coronal plane.

45. The robotic system of claim 21, wherein the plurality of sensors are disposed along a common angularly oriented plane.

46. The robotic system of claim 45, wherein the sensing array is operable to capture physical phenomena in an environment around the robot in multiple different directions along the common angularly oriented plane.

47. The robotic system of claim 23, further comprising a head-mounted display device configured to display the images to a user, the head-mounted display device comprising a display field of view;
wherein the first aggregate output and the second aggregate output comprise viewable images configured to be displayed to the user by the head-mounted display device.

48. The robotic system of claim 47, wherein the instructions, when executed by the processor, control the robotic system to:
present the first aggregate output as a first viewable stereo image to the user via the head-mounted display device.

49. The robotic system of claim 48, wherein the instructions, when executed by the processor, control the robotic system to:
display a non-overlapping portion of at least one of the first or second data, combined with the first viewable stereo image, to the user.

50. A computer implemented method of multidirectional sensing from a robot comprising one or more robot body members and a sensing array, the sensing array comprising a plurality of sensors radially supported on at least one of the one or more robot body members of the robot, the method comprising:
generating first data from a signal output by a first sensor;
generating second data from a signal output by a second sensor located on the at least one of the one or more robot body members at a first position adjacent to the first sensor;
generating third data from a signal output by a third sensor located on the at least one of the one or more robot body members at a second position adjacent to the first sensor;
combining the generated first data and second data to produce a first aggregate data output; and
combining the generated first data and third data to produce a second aggregate data output;
wherein the first sensor of the plurality of sensors is disposed to have an overlapping field of sensing with the second sensor and the third sensor.

51. The computer implemented method of claim 50, the method further comprising:
generating data from signals output by a first combination of sensors comprising at least two sensors of the plurality of sensors to generate data of a first region covered by a field of sensing of the first combination of sensors; and
generating data from signals output by a second combination of sensors comprising at least two sensors of the plurality of sensors to generate respective data of a second viewable region different from the first viewable region and covered by a field of sensing of the second combination of sensors.

52. The computer implemented method of claim 50, the method further comprising:
generating data simultaneously from signals output by the first, second, and third sensors and combining the generated data to produce an aggregate data output.

53. The computer implemented method of claim 50, wherein one or more of the first aggregate data output and the second aggregate data output comprise a first 3D depth map of an environment used by the robot to navigate the environment.

54. The computer implemented method of claim 50, wherein one or more of the first aggregate data output and the second aggregate data output comprise a first audio map used by the robot to navigate the environment.

55. The computer implemented method of claim 50, wherein the plurality of sensors comprises a plurality of cameras.

56. The computer implemented method of claim 55, wherein the first aggregate data output is a first stereo image and the second aggregate data output is a second stereo image.

57. The computer implemented method of claim 55, wherein the first aggregate data output is a first stitched image and the second aggregate data output is a second stitched image.

58. The computer implemented method of claim 55, the method further comprising:
generating data from signals output by a first combination of at least two cameras of the plurality of cameras to generate data of a first viewable region covered by the fields of view of the first combination of cameras; and
generating data from signals output by a second combination of at least two cameras of the plurality of cameras to generate respective images of a second viewable region different from the first viewable region and covered by the fields of view of the second combination of cameras.

59. The computer implemented method of claim 55, the method further comprising:
generate data simultaneously from signals output by the first, second, and third cameras and to combine the generated data to produce an aggregate data output.

60. A method for facilitating multidirectional stereo sensing by a robot comprising one or more robot body members, the method comprising:
configuring the robot to comprise a first sensor;
configuring the robot to comprise a second sensor located on the robot at least one of the one or more robot body members at a first position adjacent to the first sensor; and
configuring the robot to comprise a third sensor located on the at least one of the one or more robot body members at a second position adjacent to the first sensor;
wherein the first sensor is disposed to have an overlapping field of sensing with the second sensor and the third sensor.

61. The method of claim 60, further comprising:
configuring the first, second, and third sensors to be mounted on a common robot body member of the one or more robot body members of the robot.

62. The method of claim 60, further comprising:
configuring the common robot body member of the robot to be a head member.

63. The method of claim 60, further comprising:
configuring the first, second, and third sensors to be spaced an equidistance from each other on the robot body member of the robot.

64. The method of claim 60, further comprising:
configuring the first, second, and third sensors to be disposed along a common transverse plane of the robot.

65. The method of claim 60, further comprising:
configuring the first, second, and third sensors to be disposed along a common sagittal plane of the robot.

66. The method of claim 60, further comprising:
configuring the first, second, and third sensors to be disposed along a common coronal plane of the robot.

67. The method of claim 60, further comprising:
configuring the first, second, and third sensors to be disposed along a common angularly-oriented plane of the robot.

68. The method of claim 60, further comprising:
configuring the first, second, and third sensors to be disposed at a plurality of radial positions of the robot.

69. The method of claim 60, further comprising:
configuring the first, second, and third sensors to be radially spaced less than 360 degrees around the robot.

70. The method of claim 60, further comprising:
configuring the first, second, and third sensors to be radially spaced 360 degrees around the robot.
